(19) United States
(12) Patent Application Publication
(10) Pub. No.: US 2013/0098331 A1
(43) Pub. Date: Apr. 25, 2013

(54) METHOD FOR OPERATING A LASER SPARK PLUG FOR A COMBUSTION ENGINE

(71) Applicants: Pascal Woerner, Korntal-Muenchingen (DE); Juergen Raimann, Weil Der Stadt (DE); Martin Weinrotter, Vitoria-Gasteiz (ES)

(72) Inventors: Pascal Woerner, Korntal-Muenchingen (DE); Juergen Raimann, Weil Der Stadt (DE); Martin Weinrotter, Vitoria-Gasteiz (ES)

(21) Appl. No.: 13/642,232

(22) PCT Filed: Mar. 22, 2011
(86) PCT No.: PCT/EP2011/054349

§ 371 Date: Jan. 2, 2013

(30) Foreign Application Priority Data
Apr. 20, 2010 (DE) 102010027943.9

(51) Int. Cl. F02P 23/04

(52) U.S. Cl. CPC F02P 23/04
USPC 123/260; 123/253

(57) ABSTRACT

In a method for operating a laser spark plug for a combustion engine, the laser spark plug having a precombustion chamber, within an operating cycle of the combustion engine, the laser spark plug irradiates an ignition location situated inside the precombustion chamber with a plurality of laser ignition pulses temporally offset from one another.

### BACKGROUND OF THE INVENTION

1. Field of the Invention

The present invention relates to a method for operating a laser spark plug, as well as to a computer program and a control and/or regulating device for implementing such a method.

2. Description of the Related Art

Ignition systems for internal combustion engine are known, in which a fuel-air mixture present in a combustion chamber is ignited with the aid of a laser spark plug. In this context, it is a matter of attaining burn-through of the fuel-air mixture in the combustion chamber that is as rapid as possible, in order to achieve a low fuel consumption and improved knock characteristics. Particularly in the case of stationary gas engines, which operate with the aid of conventional high-voltage ignition, it is known that a precombustion chamber may be additionally provided for more rapid ignition of the fuel-air mixture.

### BRIEF SUMMARY OF THE INVENTION

The present invention starts out from the assumption that the use of a laser spark plug may improve the ignition of an internal combustion engine, in particular, in the case of simultaneous use of a precombustion chamber for the laser spark plug. In order to achieve optimum burn-through of the fuel-air mixture in a combustion chamber of the combustion engine, the present invention proposes that within an operating cycle of the combustion engine, the laser spark plug irradiate an ignition location situated inside the precombustion chamber with a plurality of laser ignition pulses temporally offset from one another.

In this context, it is taken into account that often, ignition already occurs while a piston of the combustion engine is still moving upwards. In this state, the fuel-air mixture (mixture) situated in the combustion chamber is increasingly compressed; a portion of the mixture being pressed into the precombustion chamber via overflow bore holes present there. If a first ignition by the laser spark plug takes place in this state, then a flame core generated by it is displaced in the flow direction of the mixture streaming into the precombustion chamber. In this context, the flame core increasing in size and the corresponding center of the flame core may therefore be moved away from the ignition location, at least temporarily. By this means, depending on the specific flow conditions, an ignitable mixture may be present once more at the ignition location. In this context, the ignition location of the laser spark plug is the point at which the light energy (laser ignition pulse) emitted by the laser spark plug is present in focused form at a high energy density. In this manner, the flow conditions in the precombustion chamber may be advantageously used for igniting more than one flame core, and thereby for igniting the mixture present in the precombustion chamber and, consequently, also in the main combustion chamber, particularly rapidly.

Thus, an advantage of the method of the present invention is that a particularly rapid burn-through in the precombustion chamber and in the combustion chamber of the combustion engine may be achieved with the aid of a laser spark plug; a fuel consumption being able to be reduced, and a susceptibility of the combustion engine to knocking being able to be improved.

Of course, depending on the operating mode of the combustion engine, it may also be sufficient to emit only one single laser ignition pulse of the laser spark plug during an operating cycle of the combustion engine, in order to ignite the mixture present in the combustion chamber. That is, it is also possible to implement the operating method of the present invention using the plurality of laser ignition pulses, in only some operating modes of the combustion engine.

In addition, it is proposed that the number of laser ignition pulses and/or a time interval between at least two of the laser ignition pulses be changed between different operating cycles of the combustion engine. This advantageously provides an option of exercising considerable influence over the ignition process and, therefore, improving the operation of the laser spark plug and the combustion engine, without an increased degree of structural complexity being necessary. The time interval between two laser ignition pulses, i.e., the spatial distance between the generated flame cores resulting due to the flow conditions in the precombustion chamber, may be selected as a function of the size of the precombustion chamber. In principle, it can be advantageous when the generated flame cores contact a wall of the precombustion chamber, or the flame cores contact one another, as late as possible, in order to consequently keep the burning time in the precombustion chamber and in the main combustion chamber as brief as possible. From this, it follows that the interval of the laser ignition pulses and the flame cores generated by them should be selected to be appropriately large.

Influence may be exerted on the number and the time interval of the laser ignition pulses, for example, by changing a pump current for operating the laser spark plug, or by changing a power of a pump pulse. In this context, for instance, a Q-switch of a solid-state laser of the laser spark plug may be caused to break down several times. The time interval of the generated laser ignition pulses may also be changed by dynamically varying the power of the pump pulse.

In combustion engines, which are used, for example, in a motor vehicle and are, consequently, dynamically loaded, it may be advantageous for the number of laser ignition pulses and/or the time interval between them to be changed, as described. However, in the case of combustion engines that are operated in a steady state, it may be sufficient to set the number of laser ignition pulses and/or the time interval between them one time and not change them during operation.

According to the present invention, it is proposed that the number of laser ignition pulses and/or the time interval between two laser ignition pulses be selected as a function of at least one of the following variables: a mixture composition of a fuel at the ignition location; a supercharging pressure at an inlet of a cylinder of the combustion engine; a gas pressure in the cylinder of the combustion engine; a rotational speed of the combustion engine; a load situation of the combustion engine; a torque of the combustion engine; a variable of an exhaust gas of the combustion engine, in particular, an exhaust gas temperature and/or the excess-air factor lambda; a temperature of a combustion chamber; a flow velocity of the mixture composition in the precombustion chamber; a geometry of the precombustion chamber; and/or a location of a center of a flame core. The variables are preferably variables, which may be ascertained or also adjusted comparatively easily, e.g., metrologically, at the combustion engine, and which have an effect on the flow velocity and/or the mixture composition in the precombustion chamber and at the ignition location. In this manner, a relationship to the required number and to the time intervals between the laser ignition pulses to be generated may be established with the objective of adapting a necessary pressure increase in the precombustion chamber to a requirement of the combustion engine at a current operating point. In this context, an objective may be to achieve as large as possible a pressure increase with short burning times.

In this manner, the method may advantageously be adapted dynamically to the operation of the combustion engine. Therefore, the interval between at least two of the consecutive laser ignition pulses is changed in accordance with current operating variables of the combustion engine. In this context, a specific ignition energy of an individual laser ignition pulse is, preferably, substantially equal to the others; in each instance, this ignition energy having to be high enough to ignite the mixture present at the ignition location. However, according to the present invention, it is also possible to generate the laser ignition pulses so as to have different ignition energies, which is possibly advantageous in the case of plasma-generating pre-ignition systems.

For example, a mixture composition of the fuel at the ignition location may be ascertained or calculated with the aid of a model, and in this manner, a criterion may be acquired for ascertaining a time for a subsequent ignition pulse of the laser spark plug at the ignition location. In addition, a supercharging pressure at an inlet of a cylinder of the combustion engine may be ascertained, and a time span between two ignition pulses may be determined as a function of the ascertained supercharging pressure. A gas pressure in the cylinder of the combustion engine may also be utilized, in order to determine the time interval between at least two of the ignition pulses. Additionally, a rotational speed of the combustion engine is suitable for influencing the ignition of the laser spark plug of the present invention. Furthermore, a load situation, a torque or a variable of an exhaust gas of the combustion engine may be utilized as a criterion for ascertaining the time interval between at least two of the ignition pulses of the laser spark plug. In addition, this may be done as a function of a temperature of the combustion chamber.

In particular, a flow velocity of the mixture composition in the precombustion chamber is also a highly suitable criterion for determining the time interval between two ignition pulses. According to the flow of the mixture during the upward movement of the piston, and according to a velocity of an expansion of the flame core generated by the laser spark plug in the precombustion chamber, the corresponding center of the flame core changes its position inside of the precombustion chamber. According to a formula

time=distance/velocity

a temporal difference between two consecutive laser ignition pulses may now be specified. In this respect, the “velocity” is the velocity at which, in each instance, a previously generated flame core moves away from the ignition location. This velocity is also influenced considerably by a flow velocity of the mixture. For example, the flow velocity of the mixture may be between 5 m/s and 15 m/s (meters per second). If a desired spatial distance between two flame cores to be generated consecutively is, for example, 5 mm, then, according to the formula, a time interval of 1000 μs to 333 μs (microseconds) results. In general, a flow velocity of 5 m/s to 15 m/s is particularly suitable for reliable ignition of the mixture.

In addition, it may be a guide value that the greater the combustion engine is currently being loaded, that is, the higher the assumed flow velocity in the precombustion chamber, as well, the smaller the time interval should be selected to be between two consecutive laser ignition pulses. Furthermore, it may be considered a practical boundary condition that a mixture currently present at the ignition location at a specific ignition firing point should be ignitable.

Moreover, the time interval between two ignition pulses may be a function of a geometry of the precombustion chamber or the main combustion chamber. For example, it may be useful to also make the time interval between two ignition pulses a function of a variable of the precombustion chamber, e.g., its volume. In addition, a location of a center of a flame core may be used for specifying the temporal spacing with regard to, in each instance, a subsequent ignition pulse.

Of course, in the case of greater than two ignition pulses temporally offset, the time intervals between, in each instance, two consecutive ignition pulses do not necessarily have to be the same. For example, it may be useful to select a time interval between a first and a second ignition pulse to be greater than a time interval between the second and a third ignition pulse, or vice versa.

Additionally, it may be provided that characteristic curves and/or characteristics maps of a control and/or regulating device be used for ascertaining and/or evaluating the variables, as well as for ascertaining the number of ignition pulses and/or their time intervals. Therefore, the multitude of variables influencing the ignition may be advantageously taken into account with the aid of characteristics maps or tables, and computing power may be conserved, and costs may be reduced.

Furthermore, the present invention proposes that in an idling mode and/or a lean full-throttle mode of the combustion engine, approximately two to approximately five ignition pulses be generated during an operating cycle. In the same manner, the present invention provides that in a full-throttle mode of the combustion engine, a maximum of approximately two ignition pulses be generated during an operating cycle.

This is based on the consideration that, on one hand, it may be an objective of the present invention to obtain a maximum pressure increase in the precombustion chamber in comparison with the combustion chamber outside of the precombustion chamber, but that on the other hand, a reduction in the pressure increase may be advantageous in certain operating states. For example, for a so-called lean full-throttle of a stationary gas engine, the ignition system may be configured to emit three ignition pulses, in which case a maximum pressure increase may be achieved.

In another operational case of the combustion engine, it may be useful, for example, to set a reduced lambda value of the exhaust gas. In this instance, an overly rapid burn-through of the mixture present in the combustion chamber may cause instances of surface ignition or manifestations of knock of the combustion engine to occur. In this case, it may be useful to reduce the number of ignition pulses generated by the laser spark plug in comparison with an operational case having a lambda value of approximately one. This may be derived, for example, from characteristics maps that are stored in a control and/or regulating device of the combustion engine.

Furthermore, during a dynamic operation of the combustion engine, a number of three or four ignition pulses may be optimum in an idling mode, while a single ignition pulse may be sufficient in a full-throttle mode. In the case last mentioned, a range of ignition flares emerging from the precombustion chamber may thereby be reduced.

In addition, it is provided that in the propagation direction, a subsequent, second ignition pulse then be generated when the center of a flame core generated by a preceding, first ignition pulse is at a first distance a from a wall section of the precombustion chamber and at a second distance b from ignition location (ZP), a ratio of first distance a to second distance b being approximately 1:5 to approximately 5:1. Consequently, a range is advantageously specified, which is suitable for implementing the method of the present invention with regard to a flow velocity of the mixture present in the precombustion chamber, as well as with regard to a geometry or size of the precombustion chamber.

Furthermore, a laser spark plug is proposed, which is suitable for applying the method, the precombustion chamber preferably having a substantially cylindrical shape with respect to a longitudinal axis. Consequently, a particularly simple shape of the precombustion chamber is specified, with the aid of which the method may be implemented. In this manner, manufacturing costs of the laser spark plug and the precombustion chamber may be reduced.

One embodiment of the laser spark plug of the present invention provides that the precombustion chamber have a substantially axially symmetric shape with respect to a longitudinal axis of the laser spark plug, one wall section of the precombustion chamber having essentially a first radius along a first axial segment, and one wall section of the precombustion chamber having essentially a second radius along a second axial segment. This describes a particularly suitable embodiment of the precombustion chamber of the spark plug according to the present invention. According to this, the precombustion chamber has essentially two different radii, the precombustion chamber being constructed to be, on the whole, axially symmetric. The sections of the precombustion chamber having a first radius and a second radius merge, for example, integrally and continuously. For example, the first wall section of the precombustion chamber, which faces the combustion chamber, has a first radius that is less than a radius of a second wall section of the precombustion chamber that faces away from the combustion chamber. In this context, the wall section of the precombustion chamber facing the combustion chamber may include, for example, a hemispherically shaped dome at its end. On the whole, the precombustion chamber consequently has an approximately pear-shaped geometry and is particularly suitable for ignition via several time-staggered ignition pulses.

Additionally, one embodiment of the laser spark plug according to the present invention provides that a ratio of the first axial segment to the second axial segment be approximately 1:2 to approximately 2:1, and that a ratio of the first radius to the second radius be approximately 1:3 to approximately 3:1. This describes a particularly suitable range of values for the dimensions of a precombustion chamber of the laser spark plug according to the present invention.

### BRIEF DESCRIPTION OF THE DRAWINGS

FIG. 1 shows a first sectional view of a precombustion chamber of a laser spark plug, including an ignition location and three flame cores generated in a time-staggered manner.

FIG. 2 shows a second sectional view of the precombustion chamber of FIG. 1, including an ignition location and a first generated flame core.

FIG. 3 shows a timing diagram including a pump pulse and two ignition pulses of the laser spark plug.

FIG. 4 shows a third sectional view of the precombustion chamber of FIG. 1, including two ignition locations and three generated flame cores for each.

### DETAILED DESCRIPTION OF THE INVENTION

In all of the figures, and even in the case of different specific embodiments, the same reference characters are used for functionally equivalent elements and variables.

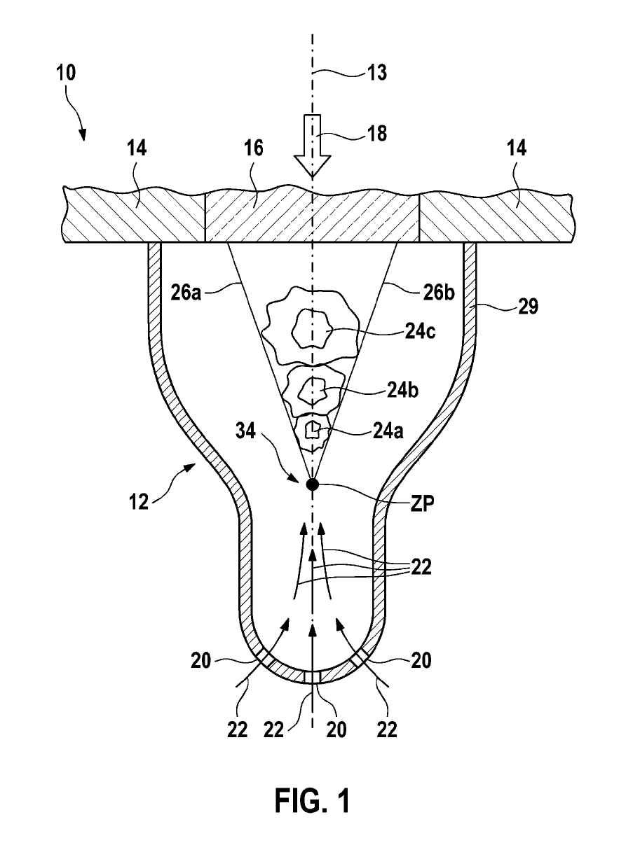

FIG. 1 shows a sectional view of a precombustion chamber 12 of a laser spark plug 10. Precombustion chamber 12 has a longitudinal axis 13 and is detachably or undetachably connected to laser spark plug 10 in a manner known per se. In addition, laser spark plug 10 is mounted, in a manner known per se, to a section of a cylinder head 14 not explained in further detail, the cylinder head being situated in the upper region of FIG. 1. Laser spark plug 10 has a combustion chamber window 16, through which concentrated laser light is emitted into combustion chamber 12 in the direction of an arrow 18. In this context, the laser light is focused onto an ignition location ZP. For example, the laser light may be generated directly in laser spark plug 10 by a Q-switched, solid-state laser, or may also be supplied to laser spark plug 10 by a remotely situated laser source. Two lines 26a and 26b circumscribe a light cone of the incoming laser light. In the lower region in the drawing, precombustion chamber 12 has three approximately identical overflow bore holes 20. Further overflow bore holes of precombustion chamber 12 are present, but are not visible in the sectional view, here.

In operation, while a fuel-air mixture (mixture) situated in a combustion chamber not identified in FIG. 1 is compressed by an upwardly moving piston (not shown), a mixture may enter the interior of precombustion chamber 12 from the combustion chamber in accordance with arrows 22. The laser light entering precombustion chamber 12 in the arrow direction of arrow 18 is focused onto ignition location ZP and may ignite a portion of the mixture present in precombustion chamber 12. In this state, a mixture normally continues to penetrate through overflow bore holes 20 into precombustion chamber 12 in accordance with arrows 22. In this manner, in the drawing of FIG. 1, an upward fluid flow is generated.

A flame core generated at ignition location ZP by a laser ignition pulse 34 moves up according to the flow direction of the mixture continuing to stream in in the drawing of FIG. 1. At the same time, it continuously increases its diameter. The flame core has, at least initially, an approximately spherical shape. In the drawing of FIG. 1, by way of example, three flame cores 24a, 24b and 24c are drawn in, starting from ignition location ZP. In this context, the flame cores 24a to 24c drawn in FIG. 1 describe either an expansion over time of a single flame core generated at ignition location ZP, or, just as well, a simultaneous arrangement of three flame cores 24a to 24c generated consecutively in accordance with the present invention.

One can see how, by generating three flame cores, a correspondingly greater volume of the mixture may be advantageously ignited, that is, in a shorter time or more rapidly, which means that a maximized pressure increase in the precombustion chamber with respect to the combustion chamber and a correspondingly more rapid burn-through of the mixture may take place, and as a result of that, a fuel consumption of the combustion engine and a knock tendency may be reduced.

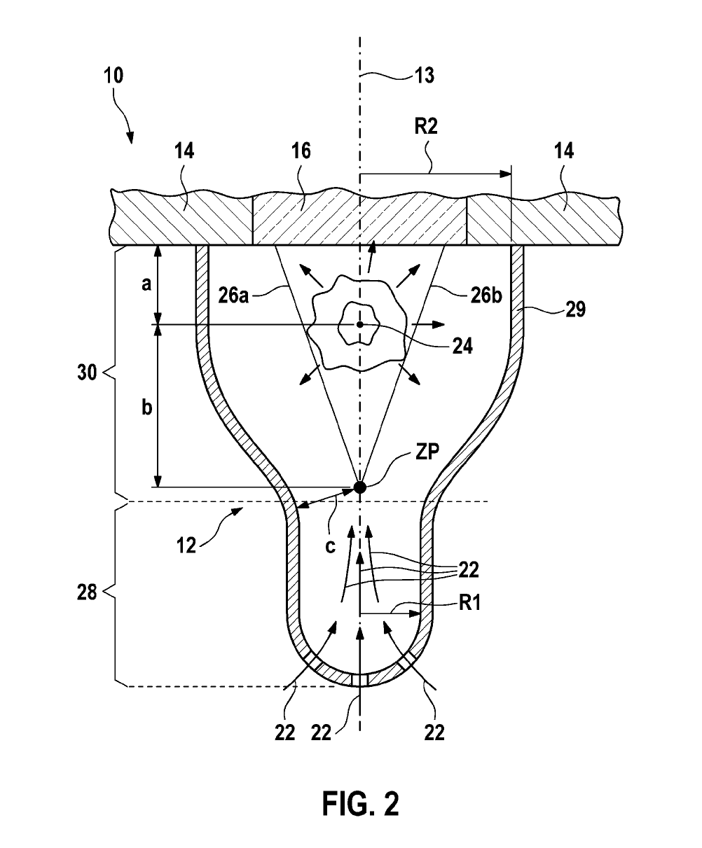

FIG. 2 shows a precombustion chamber 12 identical to that of FIG. 1. A radius R1 for a first axial segment 28 of precombustion chamber 12 in the drawing of FIG. 2 and a radius R2 for a second axial segment 30 of precombustion chamber 12 in the drawing are illustrated with respect to longitudinal axis 13. In the present case, a ratio of radius R1 to radius R2 is approximately 1:3.

Illustrated in FIG. 2 is an instant in which a flame core generated previously, along with its center of the flame core 24, has already moved up in the drawing, away from ignition location ZP by a second distance b. At this time, center of the flame core 24 is at a first distance a from combustion chamber window 16 of cylinder head 14. In this case, a ratio of first distance a to second distance b is approximately 1:2. In this context, the flame core drawn in FIG. 2 is the first of a sequence of two flame cores or ignition pulses to be generated.

A third distance c, which describes a minimum distance between ignition location ZP and a wall 29 of precombustion chamber 12, is also recorded in FIG. 2. Third distance c may be used for obtaining a guide value for the dimensioning of distance a, and therefore, for the chronological sequence of the laser ignition pulses. It is important that the flame cores reach wall 29 of precombustion chamber 12 as close as possible to the same time and as late as possible, and that consequently, rapid burn-through is achieved.

At the same time, the drawing of FIG. 2 shows the instant, at which a second flame core having a further center of the flame core 24 (not shown) may be generated at ignition location ZP. Using the ratio of distances a to b, a suitable time for the second laser ignition pulse may therefore be specified. In this context, the ratio of a to b may be advantageously ascertained in view of the following variables of the combustion engine:
a mixture composition of a fuel at ignition location ZP;
a supercharging pressure at an inlet of a cylinder of the combustion engine;
a gas pressure in the cylinder of the combustion engine;
a rotational speed of the combustion engine;
a load situation of the combustion engine;
a torque of the combustion engine;
a variable of an exhaust gas of the combustion engine;
a temperature of a combustion chamber;
a flow velocity of the mixture composition in precombustion chamber 12;
a geometry of precombustion chamber 12; and/or
a location of a center of a flame core 24.

In this manner, several operating states of the combustion engine may be used for selecting, in each instance, an optimum number of, and optimum time intervals between, the laser ignition pulses of laser spark plug 10.

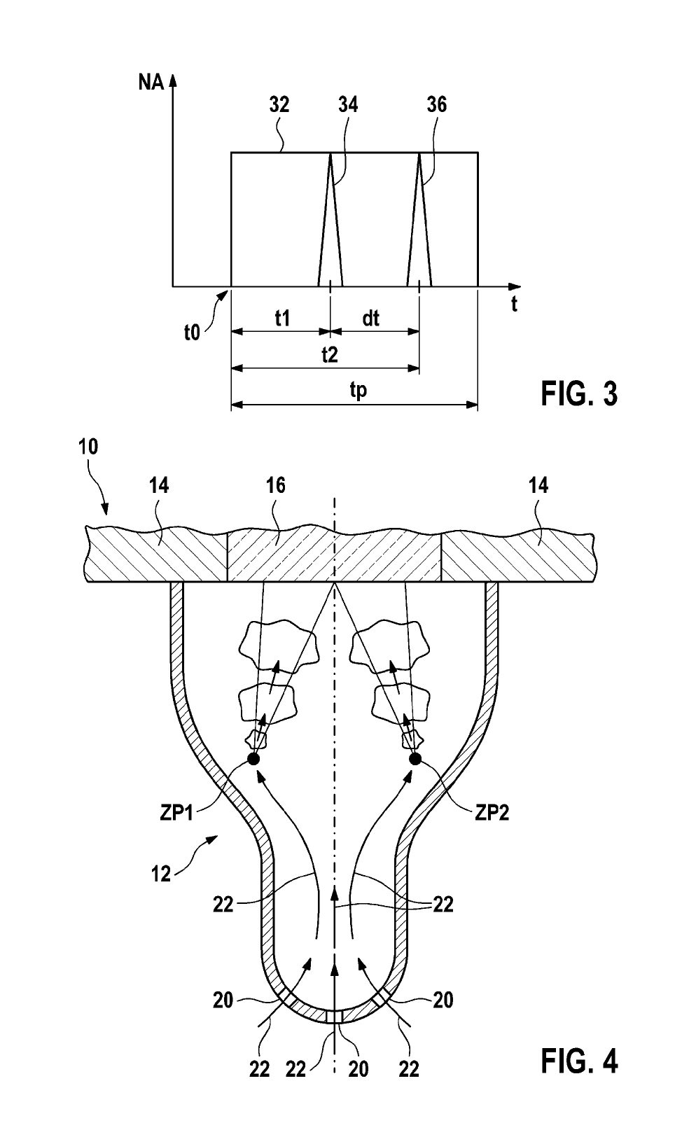

FIG. 3 shows a timing diagram of a normalized amplitude NA of a laser pump pulse 32 and two ignition pulses 34 and 36 generated from it, as are produced by applying pump pulse 32 to a passive, Q-switched laser system known per se. In this context, the abscissa of the illustrated coordinate system designates time t, and the ordinate designates normalized amplitude NA. A pump pulse 32, which has a time span tp in FIG. 3, is generated at time t0. Using time t0 as a starting point, a first laser ignition pulse 34 is generated after a time t1 elapses. A second laser ignition pulse 36 is generated after a time t2 elapses. Thus, in this case, laser ignition pulses 34 and 36 have a time interval dt=t2−t1. In the graph of FIG. 3, a total of two ignition pulses are generated during a laser pump pulse 32.

By increasing the pump current or the power of pump pulse 32 and/or the pumping duration via an increase in time span tp, more than two ignition pulses 34 and 36 may also be generated, if necessary, and used for the ignition, in that a Q-switch of a solid-state laser of laser spark plug 10 (FIG. 1) is caused to break through multiple times. Likewise, time interval dt of generated laser ignition pulses 34 and 36 may also be changed by dynamically varying the power of pump pulse 32 during time span tp. However, this is not illustrated in the drawing of FIG. 3.

It should be noted that the durations of ignition pulses 34 and 36 and/or the duration of pump pulse 32, which are drawn in FIG. 3, may not be illustrated to scale with respect to one another. For example, ignition pulses 34 and 36 have a duration of 1 ns to 10 ns (nanoseconds), and pump pulse 32 has a duration of 100 μs (microseconds) to 1000 μs.

FIG. 4 illustrates a mechanical construction of precombustion chamber 12 that is similar to that of FIGS. 1 and 2. In this case, the laser light irradiated by laser spark plug 10 is focused in such a manner, that two ignition locations ZP1 and ZP2 different from one another are acted upon by it. The chronological sequence of the ignition pulses is similar to those of FIGS. 1 and 2. In FIG. 4, the generated flame cores are only alluded to (without reference numerals).

The ignition of the mixture situated in combustion chamber 12 may be improved by forming two different ignition locations ZP1 and ZP2, in that two times the number of flame cores and centers of flame cores are generated. Accordingly, more rapid burn-through of the mixture situated in precombustion chamber 12 may be advantageously achieved, and the fuel consumption of the combustion engine, as well as a knock tendency, may be further reduced.

A further specific embodiment of laser spark plug 10 (not shown) for implementing the method of the present invention has a shape not axially symmetric with respect to longitudinal axis 13. Due to a special design of an interior of precombustion chamber 12, a tangential flow of the fuel-air mixture in front of combustion chamber window 16 is generated. Accordingly, the at least one flame core is moved, at least in the beginning, approximately perpendicularly to longitudinal axis 13. The principle of the temporally repeated ignition of the present invention is generally applicable in the case of laser spark plugs not having a precombustion chamber, as well.

1-13. (canceled)

14. A method for operating a laser spark plug for a combustion engine, the laser spark plug having a precombustion chamber, the method comprising:
irradiating by the lasser spark plug, within an operating cycle of the combustion engine, an ignition location situated inside the precombustion chamber with a plurality of laser ignition pulses temporally offset from one another.

15. The method as recited in claim 14, wherein:
at least one of (i) the number of laser ignition pulses and (ii) a time interval between at least two of the laser ignition pulses is changed for different operating cycles of the combustion engine.

16. The method as recited in claim 15, wherein the at least one of (i) the number of laser ignition pulses and (ii) the time interval between the at least two laser ignition pulses is selected as a function of at least one of the following control variables:
(a) a mixture composition of a fuel at the ignition location;
(b) a supercharging pressure at an inlet of a cylinder of the combustion engine;
(c) a gas pressure in a cylinder of the combustion engine;
(d) a rotational speed of the combustion engine;
(e) a load condition of the combustion engine;
(f) a torque of the combustion engine;
(g) a characteristic variable of an exhaust gas of the combustion engine;
(h) a temperature of a combustion chamber;
(i) a flow velocity of the mixture composition in the precombustion chamber;
(j) a geometry of precombustion chamber; and
(k) a location of a center of a flame core.

17. The method as recited in claim 16, wherein at least one of:
(i) at least one of a characteristic curve and a characteristics map of a control device is used for at least one of ascertaining the control variables, evaluating the control variables, ascertaining the number of laser ignition pulses, and ascertaining the time interval between the at least two laser ignition pulses; and
(ii) metrologically ascertained data are used for at least one of ascertaining the control variables, evaluating the control variables, ascertaining the number of laser ignition pulses, and ascertaining the time interval between the at least two laser ignition pulses.

18. The method as recited in claim 16, wherein in at least one of an idling mode and a full-throttle mode of the combustion engine adjusted to be lean, approximately two to five laser ignition pulses are emitted during an operating cycle.

19. The method as recited in claim 16, wherein in a full-throttle mode of the combustion engine, a maximum of approximately two ignition pulses are emitted during a working cycle.

20. The method as recited in claim 18, wherein:
a first ignition pulse is emitted; and
a subsequent, second ignition pulse is emitted, when, in the propagation direction, the center of the flame core generated by the preceding first ignition pulse is (i) at a first distance from a wall section of the precombustion chamber and (ii) at a second distance from the ignition location, a ratio of the first distance to the second distance being approximately 1:5 to approximately 5:1.

21. A laser spark plug for a combustion engine, comprising:
a precombustion chamber; and
a laser pulse emitter configured to irradiate an ignition location situated inside the precombustion chamber with a plurality of laser ignition pulses temporally offset from one another.

22. The laser spark plug as recited in claim 21, wherein the precombustion chamber has a substantially axially symmetric shape with respect to a longitudinal axis of the laser spark plug, a wall section of the precombustion chamber having a first predefined radius along a first axial segment, and a wall section of the precombustion chamber having a second predefined radius along a second axial segment.

23. The laser spark plug as recited in claim 22, wherein a ratio of the first axial segment to the second axial segment is approximately 1:2 to approximately 2:1, and a ratio of the first radius to the second radius is approximately 1:3 to approximately 3:1.

24. The laser spark plug as recited in claim 21, wherein at least one of the precombustion chamber and an overflow channel situated in the precombustion chamber is configured to provide at least partially tangential flow of a fuel-air mixture in front of a combustion chamber window.

25. A non-transitory computer-readable data storage medium storing a computer program having program codes which, when executed on a computer, performs a method for operating a laser spark plug for a combustion engine, the laser spark plug having a precombustion chamber, the method comprising:
irradiating by the lasser spark plug, within an operating cycle of the combustion engine, an ignition location situated inside the precombustion chamber with a plurality of laser ignition pulses temporally offset from one another;
wherein at least one of (i) the number of laser ignition pulses and (ii) a time interval between at least two of the laser ignition pulses is changed for different operating cycles of the combustion engine.

26. A control device for operating a laser spark plug for a combustion engine, the laser spark plug having a precombustion chamber, comprising:
a control element for controlling the laser spark plug within an operating cycle of the combustion engine such that the lasser spark plug irradiates an ignition location situated inside the precombustion chamber with a plurality of laser ignition pulses temporally offset from one another;
wherein at least one of (i) the number of laser ignition pulses and (ii) a time interval between at least two of the laser ignition pulses is changed for different operating cycles of the combustion engine.
